(19) United States
(12) Patent Application Publication
(10) Pub. No.: US 2009/0001834 A1
(43) Pub. Date: Jan. 1, 2009

(54) Permanent magnet motor

(76) Inventors: Doyle Ray Ledbetter, Greenwood, IN (US); Doyle Ray Ledbetter, JR., Ashville, NC (US)

Correspondence Address: Doyle Ray Ledbetter, 5239 Summerfield Crossing, Greenwood, IN, 46143, US

(21) Appl. No.: 12/228,313

(22) Filed: Aug. 11, 2008

Related U.S. Application Data
(63) Continuation of application No. 11/453,687, filed on Jun. 15, 2006.
(60) Provisional application No. 60/690,783, filed on Jun. 15, 2005.

(51) Int. Cl. H02K 21/26; H02K 53/00

(52) U.S. Cl. 310/154.03; 415/916

(57) ABSTRACT

There is disclosed herein a Permanent Magnet powered motor that can be used in many applications. Larger units can be used to power automobiles based on rotor design and strength of magnets while smaller units can provide rotating power similar to any electric motor application. Electric power is not required to operate this motor thus removing the need for electrical power except for resistance components such as lighting.

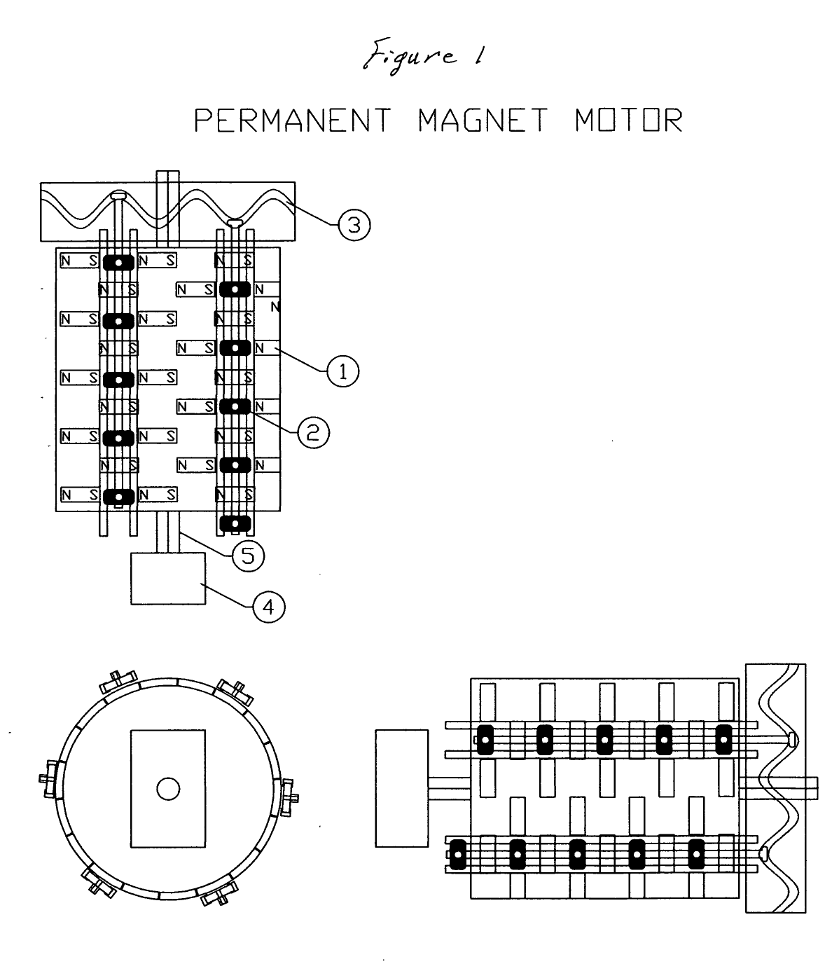

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Technical Field of Invention

This invention relates generally to a motor powered by permanent magnets requiring external power only to start, control direction, and speed of the motor using mechanical devices.

2. Discussion of Related Art Electric motors are typically powered by either alternating current (AC) or direct current (DC) power. This limits the operation to either stationary (AC) or battery powered (DC) for mobile applications.

While the (AC) system is very reliable and almost maintenance free, the (DC) system is limited in hours of operation by battery capacity.

New technology is being developed for the improvement of battery design but this is still a device that requires service (charging) in order to be available for daily use.

Current permanent magnet motors use electromagnetic and/or electronic switching devices to control the flux fields and pulse the windings in order to cause the rotating member to move in the direction desired and at the desired revolutions per minute.

3. Disadvantages of Prior Art

Although prior developments of Permanent Magnet Powered Motors have improved the power requirements per horsepower, the basic need for electromagnetic and/or electronic switching continues to use battery power to function—thus limiting time of operation to the power stored in the battery.

### OBJECTS AND ADVANTAGES

It is an objective of the present invention to overcome the disadvantages of the prior art by providing an improved means to utilize permanent magnets to create rotating force in order to accomplish work, i.e. powering an automobile.

### DRAWING—TYPICAL PERMANENT MAGNET MOTOR

(1) Rotor mounted permanent magnet

(2) Cam controlled “Fixed” permanent magnet

(3) Control cam

(4) Motor—Generator

(5) Rotor

### DETAILED DESCRIPTION OF THE PREFERRED EMBODIMENT

The following description of the preferred embodiment is merely exemplary in nature and is not intended to limit the invention, its application, or uses.

Item (1) is a series of rows of permanent magnets mounted radially around the rotor. The magnets are positioned to create both pulling and pushing force as they react to the “Fixed” magnets item (2). The “Fixed” permanent magnets are held in position preventing radial movement but move axially causing the magnetic fields to be moved from one row of rotor mounted magnets to the adjacent row.

The Control Cam (3) is mounted to the rotor and translates the radial movement into axial movement. As this cam moves the “Fixed” magnets into line with the rows of rotor mounted magnets the pulling and pushing forces are mechanically switched between adjacent rows causing rotation of the rotor.

The motor—generator (4) is connected to the rotor shaft. This motor is used to start the rotor turning and then recharges the battery allowing unlimited time of operation. This unit is only required on larger motors. Small motors that can easily be started by other means will not require this device.

The rotor (5) is a heavy non-magnetic component that supports the radially mounted magnets and smoothes out the pulses caused by the individual magnetic forces.

### CONCLUSION

The foregoing discussions, disclosures and describes are merely exemplary embodiments of the present invention. One skilled in the art will readily recognize from such discussion and from the accompanying drawing and claims, that various changes, modifications and variations can be made therein without departing from the spirit and scope of the invention as defined in the following claims.

What is claimed:

1. Continuous operating motor requiring no external energy source except starting rotation energy comprised of:
1. Permanent magnets mounted radially on a rotor
2. “Fixed” permanent magnets acting on the rotor mounted magnets
3. Control cam to axially move the “Fixed” permanent magnets
4. Motor—generator to provide starting energy and battery recharging capacity
5. Non magnetic rotor
